(19) United States
(12) Patent Application Publication
(10) Pub. No.: US 2015/0090617 A1
(43) Pub. Date: Apr. 2, 2015

(54) STORING AND MIXING DEVICES

(71) Applicant: MYY FEED LIMITED, Loughborough (GB)

(72) Inventor: Dewan Syed Ahsanur Reza, Loughborough (GB)

(21) Appl. No.: 14/398,326

(22) PCT Filed: May 1, 2013
(86) PCT No.: PCT/GB2013/051130

§ 371 Date: Oct. 31, 2014

(30) Foreign Application Priority Data
May 4, 2012 (GB) 1207842.4
Feb. 5, 2013 (GB) 1301978.1

(51) Int. Cl. A61J 1/20

(52) U.S. Cl. CPC A61J 1/2093
USPC 206/221

(57) ABSTRACT

A storing and mixing device (1) comprising a first chamber (2) to store a first substance and a second chamber (4) to store a second substance, the chambers (2, 4) being removably attached to each other. An opening (26) is located between the two chambers (2, 4) which is sealed by a plugging device (24) housed in the first chamber (2). Operation of an actuation means (32), located on a lid (20) of the first chamber (2), contacts and engages with the plugging device (24) in order to remove the plugging device (24) from the opening (26). The contents of the two chambers (2, 4), for example, powdered baby formula and hot water, are then permitted to mix.

### FIELD OF THE INVENTION

The present invention relates to devices for storing and mixing two separate components, and in particular to devices which allow a user to store and subsequently mix the component elements necessary to make a baby feeding formula.

### BACKGROUND TO THE INVENTION

The majority of infants will be fed on powdered baby formula at some point during their early years. Baby formula is often used by parents to supplement a mother's natural milk supply to their child, as well as being used to consolidate an early diet for infants during and after weaning has commenced. Although there are several brands of powdered baby formula on the market, the preparation of baby formula has remained largely unchanged since Justus von Liebig developed the world's first commercial infant formula in 1867.

The standard way in which powdered baby formula is converted into a liquid product suitable for an infant to drink, is to measure out an amount of dry powdered baby formula which is then mixed with a quantity of boiled water. The amount of formula, and hence the water that is required, will vary according to an infant's demands. Current guidelines indicate that an infant between the ages of two to six months should consume 120-180 ml of formula per feed (4-6 ounces), up to a total of around 900 ml per day (30 ounces). Typically formula is prepared ‘on demand’ as and when it is required. This can often lead to problems when dealing with a hungry infant, as boiled water must be prepared, and an accurate quantity of formula must be measured out. This will often take time, which is something that a hungry infant will not understand. In addition, it is entirely possible that a parent may be out for the day and therefore away from suitable kitchen facilities which are required in order to prepare baby formula.

It would be advantageous to have a system where a predetermined amount of powdered formula, and the associated volume of boiled water, may be stored securely prior to being required for feeding. It would be particularly advantageous if the components could be stored separately and securely without any worries of deterioration of the component constituents. It would also be highly advantageous if the device to store a predetermined quantity of baby formula was portable allowing a parent to make up a ‘feed’ in advance and to transport it around with them until it is required.

### SUMMARY OF THE INVENTION

Accordingly, the present invention provides a device for storing separately and then mixing two substances, the device comprising:
a first chamber having:
   a first opening to the exterior of the device;
   a second opening sealed by a plugging device; and
   means for removably attaching a second chamber to the second opening;
a lid capable of closing the first opening, the lid having actuation means movable from a storing position to a mixing position, thereby to engage with the plugging device and to separate the plugging device from the second opening;
wherein the device comprises means for releasably securing the plugging device to the actuation means.

The device allows the parent or guardian of an infant to measure out and store the component constituents of a baby formula feed separately, prior to the formula being required. When the feed is required, the component parts (powdered formula and boiled water) are allowed to mix together, therefore preventing deterioration of the powdered formula until that time. The invention therefore allows fresh formula feed to be prepared on demand as and when it is required by an infant. It is also envisaged that the device may be used to store separately and then combine other components which may be perishable or combine in an unwanted manner once they are brought into contact with each other, for example dried tea leaves and water.

For the purpose of describing features of the invention, the term ‘chambers’ refers to an embodiment of the invention which is supplied with two chambers, a first chamber and a second chamber, which have means of attachment for detachably releasing to one another. It is also envisaged in an alternative embodiment of the invention that the invention may be supplied with only a first chamber, allowing a user to releasably attach the first chamber to an existing second chamber (e.g. a baby bottle) that they currently own. This may be accomplished directly or via intermediate connection means, e.g. an adapter, such that the first chamber may be attached to a variety of second chambers (baby bottles) currently on sale in the market.

Any references herein to a second chamber refer purely to features or characteristics of a chamber that may be sold by the applicant. It is not intended to limit the scope of the invention to that particular embodiment, or to specific types of second chamber (baby bottle) that the first chamber may be releasably attachable to.

In accordance with the invention, the device comprises two separate chambers; one for storing a supply of powdered baby formula, and the second for storing a supply of boiled water. The chambers are shaped and dimensioned so that they may connect to each other. The chambers have connection means in order for them to be removably attached, so that they may be joined and further separated from each other after use. Preferably the chambers are connected by screw type connection means, although it will be appreciated by a skilled person that any sort of known removable connection means may be employed. For example, a snap-fit connection means.

The chambers may be constructed from any suitable material, for example a thermoplastic material, such as a polycarbonate material, or an appropriate silicone material. Most importantly, the material will be free from BPA (Bisphenol A), phthalates and other lead containing compounds which are unsuitable for use in baby feeding containers. They may be translucent in order to allow a user to view the contents of the chambers. Preferably the material is durable and thermally insulating. In an embodiment of the invention, the second chamber comprises a double wall with vacuum insulation means in order to maintain the temperature of the water. In an alternative embodiment of the invention, the device may be mounted in a container formed from an insulating material, e.g. a stainless steel container incorporating a double wall insulating system having a vacuum between the two walls, in order to maintain the temperature of the water in the second chamber.

The first chamber comprises a first opening between the chamber and the exterior of the device which is sealable by a lid, and a second opening from the first chamber to the second chamber which is sealed by a plugging device. The internal walls of the first chamber are preferably sloped towards the second opening so that the contents of the first chamber are directed to fall towards the second opening when the plugging device is removed. The first chamber may be sized to accommodate the appropriate quantity of powdered formula for a feed. The first chamber may be sized to accommodate sufficient powder to prepare a 180 ml feed (approximately 6 ounces), although it will be appreciated that reduced or increased quantities of powder may be stored depending on a user's requirement. The second chamber may comprise a volume which allows a user to store the appropriate quantity of water needed e.g. in the case when sufficient powder for a 180 ml feed is stored in the first chamber, the equivalent volume of water required (180 ml or six ounces) may be stored in the second chamber.

The second chamber may comprise internal measuring bars located on an inner surface to allow a user to measure the appropriate quantity of water into the second chamber when the detachable modules are connected together.

The lid is also preferably constructed from the same thermoplastic material as the chambers, and further may comprise the same screw type attachment in order to securely connect to the first chamber, in an analogous way to the first chamber being connected to the second chamber. It is anticipated that the lid may also connect to the first chamber by any other suitable connection means known in the art.

The plugging device is also preferably constructed from the same thermoplastic material as the chambers and the lid. The plugging device comprises a base portion which is shaped and dimensioned to seal the second opening of the first chamber, and a body portion which is shaped and dimensioned to engage with the lid. The plugging device may preferably comprise a rubber sealing ring located around the perimeter of the base portion of the plugging device, so that the plugging device is supported around the second opening. Preferably the plugging device comprises means for releasably clipping the plugging device to the second opening.

The lid further comprises actuation means in order to operate the device and effect the mixing of the components stored in the first and second chambers. Preferably the actuation means is formed by a deformable membrane which is attached to the lid, and further supported by inner and outer ring shaped projections which extend from a lower surface of the lid. A portion of the deformable membrane extends through an opening in the lid, which is defined by the inner ring shaped projection. The actuation means is movable from a storing position to a mixing position, thereby to engage with the body portion of the plugging device and separate the plugging device from the second opening. Preferably the body of the plugging device comprises means for releasably securing the plugging device to attachment means on the deformable membrane e.g. by clipping. In a preferred embodiment of the invention, the deformable membrane remains in the mixing position after actuation. Operation of the actuation means permits at least a portion of the deformable membrane to move from a stable, convex configuration in the storing position, through an unstable intermediate configuration, to a stable, concave configuration in the mixing position, The membrane is guided and supported by the inner ring projection during operation of the actuation means. Preferably the plugging device is supported by the deformable membrane after the plugging device has been separated from the second opening, so that the plugging device is held in suspension between the first and second chambers and the second opening remains open.

The device may be operated as follows. Prior to use, the plugging device is first inserted into the second opening of the first chamber to prevent the contents of the chamber from emptying. A user may fill the first chamber with an amount of powdered formula through the first opening as required. After the chamber is filled the lid is attached to the first opening of the first chamber. A user may fill the second chamber with an amount of boiled water as required. After the first and second chambers have been filled, the two chambers are connected together using the screw type attachment means. It will be appreciated by a person skilled in the art that the steps of filling the first and second chambers with respective powdered formula and boiled water may be carried out in either order.

When a feed is required, a user will operate the actuation means to deploy the plugging device and effect the mixing of the powdered formula and the boiled water. Downward pressure is applied to the deformable membrane actuation means to move it from a storing position to a mixing position. The deformable membrane moves from a stable, convex configuration in the storing position, through an unstable intermediate configuration, to a stable, concave configuration in the mixing position. As it does so, the membrane first engages with the releasable securing means of the body portion of the plugging device. Continued movement of the membrane forces the removal of the base portion of the plugging device from the second opening. The powdered formula and water are then permitted to mix, with the powdered formula passing from the first chamber to the second chamber via the second opening. The releasable clipping means of the plugging device prevent the plugging device from becoming detached from the deformable membrane and dropping into the second chamber. Instead, the plugging device remains in the mixing position, held in suspension between the first and second chambers so that the second opening remains open. The contents of the container may further be shaken to effect mixing of the baby formula.

The invention as described above solves the problems of providing a storing and mixing device which allows a user to prepare a quantity of baby formula on demand. In particular the device allows the component constituents needed to prepare baby formula to be stored separately without degradation of the powder. Powder that has been previously mixed with boiled water has a shelf life of only a few hours before it is recommended that the mixture is thrown away. The storing and mixing device described above also has the advantage that it is portable, which allows a parent to measure out the powdered formula and water in advance. They can then take it with them on a day out and combine the elements together when they are needed.

Specific embodiments of the invention are now described by way of example and with reference to the accompanying drawings in which like numerals are used to indicate like parts.

### DRAWINGS

FIG. 1 is a view in cross-section of the second chamber of the storing and mixing device;

FIG. 2 is a view in cross-section of the lid of the storing and mixing device;

FIG. 3 is a view in cross-section of the first chamber of the storing and mixing device;

FIG. 4 is a view in cross-section of the assembled components of FIGS. 1-3;

FIG. 5 is a view in cross-section of the actuation means of the storing and mixing device in the storing or at rest position;

FIG. 6 is a view in cross-section of the actuation means of the storing and mixing device in an intermediate position; and

FIG. 7 is a view in cross-section of the actuation means of the storing and mixing device in the mixing or activated position.

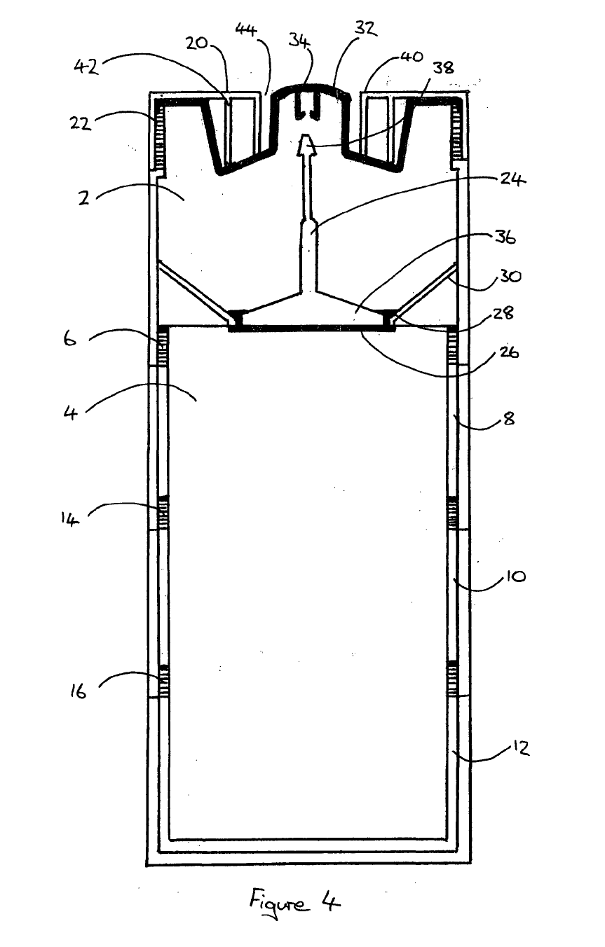

Referring now to the drawings, FIGS. 1, 2 and 3 show the component parts of the apparatus comprising the storing and mixing device 1, as described in more detail below. FIG. 4 shows the component parts of the storing and mixing device 1 connected together prior to use.

The storing and mixing device 1 comprises a first chamber 2 and a second chamber 4 which are removably connected to each other by screw connection means 6. It can be seen from FIG. 1, that the second chamber 4 comprises three detachable modules 8, 10, 12 each having screw type connection means 6, 14, 16. The modules 8, 10, 12 are shaped and dimensioned in order to fit together. In this embodiment of the invention, screw connection means 6 are used to connect the first chamber 2 to the second chamber 4.

The first chamber 2 and detachable modules 8, 10, 12 forming the second chamber 4 are constructed from a thermoplastic material. FIG. 3 shows the first chamber 2 having a first opening 18 which is closable by a lid 20 that is connected to the first chamber 2 by screw type attachment means 22. The first chamber 2 further comprises a plugging device 24 which is retained in a second opening 26 of the first chamber 2, located in an opposing surface of the first chamber 2 to the lid 20. The plugging device 24 additionally comprises a rubber sealing ring 28 located around a perimeter of the plugging device 24. The internal walls 30 of the first chamber 2 slope towards the plugging device 24 and second opening 26.

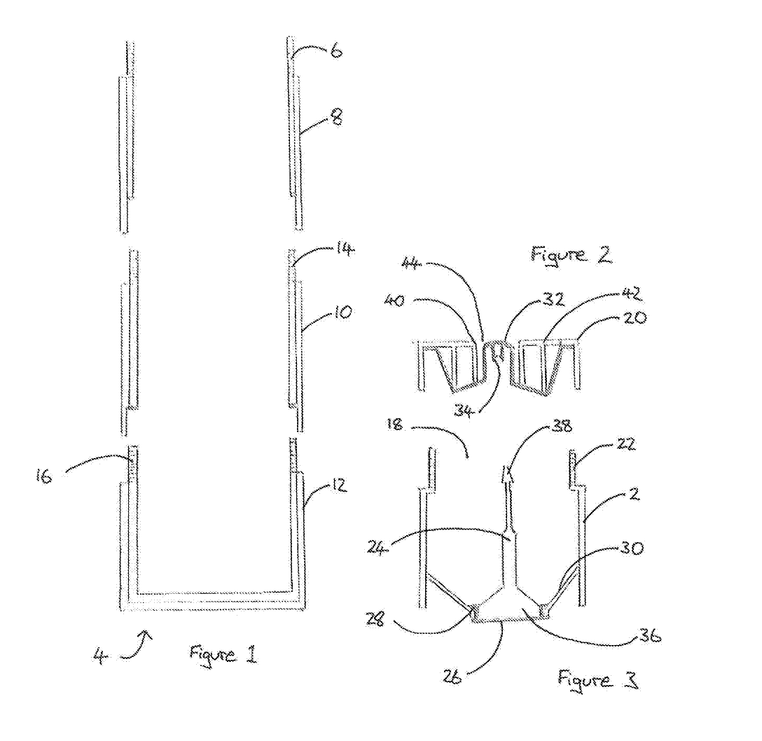

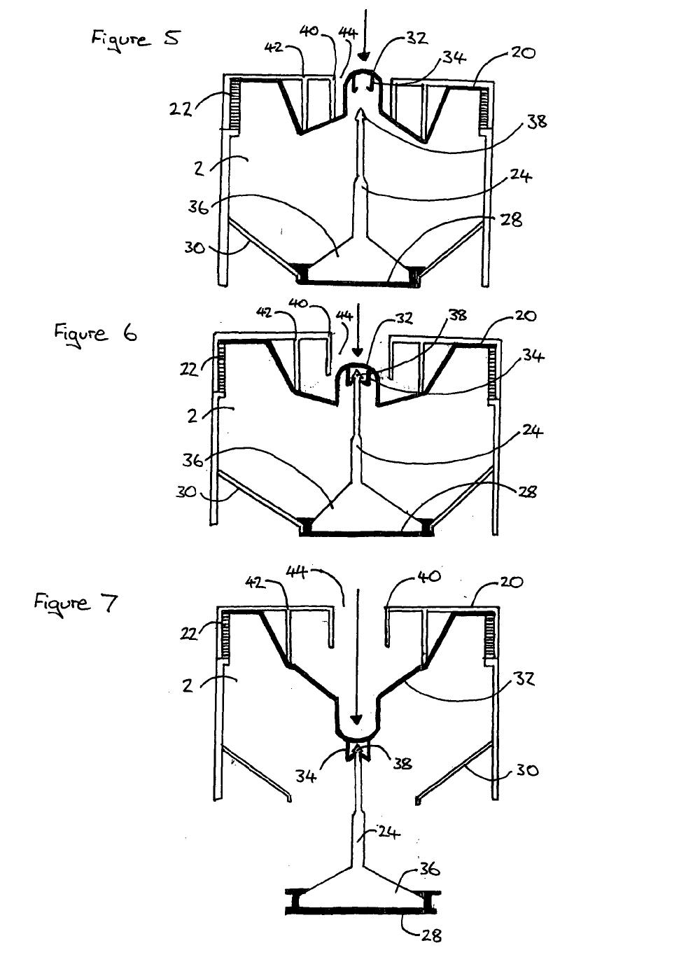

The lid 20 is also formed from the same thermoplastic material and is shaped and dimensioned to engage with the first opening 18 of the first chamber 2. FIG. 2 shows that the lid 20 further comprises an inner and outer ring shaped projection 40, 42 extending from a lower surface of the lid 20 to support a deformable membrane actuation means 32. A portion of the deformable membrane 32 extends through an opening 44 in the lid 20, the opening 44 being defined by the walls of the inner ring projection 40. The deformable membrane 32 is movable from an at rest or storing position as can be seen in FIG. 5, through an intermediate position as can be seen in FIG. 6, to an actuated or mixing position as can be seen in FIG. 7. Located on a lower surface of the deformable membrane 32 are releasable securing means 34 that are shaped and dimensioned to engage with the plugging device 24 with a clipping action, in order to separate the plugging device 24 from the second opening 26 upon activation of the deformable membrane 32.

The plugging device 24 is also formed from the same thermoplastic material and comprises a base portion 36 and a body portion 38. The base portion 36 is shaped and dimensioned to be retained by the second opening 26 of the first chamber 2, and held securely in place by the rubber sealing ring 28. An end of the body portion 38 of the plugging device 24 is shaped and dimensioned to be engaged by the releasable clipping means 34 of the deformable membrane 32.

The assembled device 1 is operated as follows with regards the embodiment shown in FIG. 4 and the operation of the actuation means 32 as shown in FIGS. 5 to 7. Prior to use, the plugging device 24 is first inserted into the second opening 26 of the first chamber 2 to prevent the contents of the chamber 2 from emptying. A user fills the first chamber 2 with an amount of powdered formula through the first opening 18 as required. After the chamber 2 is filled the lid 20 is attached to the first opening 18 of the first chamber 2. A user fills the second chamber 4 with an amount of boiled water as required. After the first and second chambers 2, 4 have been filled, the two chambers 2, 4 are connected together using the screw type attachment means 6.

The device 1 is now prepared for operation. When a feed is required, a user operates the actuation means 32 to deploy the plugging device 24 and effect the mixing of the powdered formula and the boiled water. Downward pressure is applied to the deformable membrane actuation means 32 to move it from a storing position to a mixing position. The deformable membrane 32 moves from a stable, convex configuration in the storing position, through an unstable intermediate configuration, to a stable, concave configuration in the mixing position. As it does so, the releasable clipping means 34 of the membrane 32 first engages with the body portion 38 of the plugging device 24 then continued movement of the membrane 32 forces the removal of the base portion 36 of the plugging device 24 from the second opening 26. As a result, the sloped internal walls 30 of the first chamber 2 direct the powdered formula towards the second opening 26 when the plugging device 24 is removed. The powdered formula passes into the second chamber 4 where it is permitted to mix with the water. The releasable clipping means 34 of the deformable membrane 32 prevent the plugging device 24 from becoming detached from the deformable membrane 32 and dropping into the second chamber 4. Instead, the plugging device 24 remains in the mixing position, held in suspension between the first and second chambers 2, 4 so that the second opening 26 remains open.

1. A device for storing separately and then mixing two substances, the device comprising:
a first chamber comprising:
a first opening to the exterior of the device;
a second opening sealed by a plugging device; and
means for removably attaching a second chamber to the second opening;
a lid capable of closing the first opening, the lid having actuation means movable from a storing position to a mixing position, thereby to engage with the plugging device and to separate the plugging device from the second opening;
wherein the device comprises means for releasably securing the plugging device to the actuation means.

2. A storing and mixing device according to claim 1, wherein the actuation means remains in the mixing position after actuation.

3. A storing and mixing device according to claim 1, wherein the actuation means is formed by a deformable membrane.

4. A storing and mixing device according to claim 3, wherein at least a portion of the deformable membrane moves from a stable, convex configuration in the storing position, through an unstable intermediate configuration, to a stable, concave configuration in the mixing position.

5. A storing and mixing device according to claim 4, wherein the movement of the deformable membrane is guided and supported by a projection extending from the lid.

6. A storing and mixing device according to claim 5, wherein the projection is ring shaped.

7. A storing and mixing device according to claim 1, further comprising a second chamber attached to the first chamber.

8. A storing and mixing device according to claim 1, wherein the plugging device is supported around the second opening while the plugging device seals the second opening and wherein the plugging device is supported by the actuation means after the plugging device has been separated from the second opening.

9. A storing and mixing device according to claim 1, comprising means for releasably clipping the plugging device to the second opening.

10. A storing and mixing device according to claim 1, wherein the securing means for releasably securing the plugging device comprises a clipping means.

11. A method of storing separately and then mixing two substances using a storing and mixing device according to claim 1, the method comprising the steps of:
filling the first chamber with an amount of a first substance through the first opening,
after filling the first chamber, closing the first opening with the lid,
filling the second chamber with an amount of a second substance,
after filling the second chamber, attaching the second chamber to the first chamber, and
moving the actuation means from a storing position to a mixing position thereby to releasably secure the plugging device to the actuation means and to separate the plugging device from the second opening.

12. A method according to claim 11, further comprising a preliminary step of engaging the plugging device with the second opening to seal the second opening.

13. A method according to claim 11, wherein the actuation means remains in the mixing position after actuation.

14. A device for storing separately and then mixing two substances, the device comprising:
a first chamber comprising a first opening and a second opening formed therein, wherein the first chamber further comprises at least one wall sloped towards the second opening;
a plugging device sealably aligned with the second opening;
a lid connected to the first opening, wherein the lid comprises an actuator movably engageable with the plugging device.

15. The device of claim 14, further comprising a second chamber removably attached to the first chamber, and wherein the second opening of the first chamber opens to the second chamber;

16. The device of claim 14, wherein the plugging device comprises a base portion dimensioned to seal the second opening.

17. The device of claim 16, wherein the plugging device further comprises a body portion engagable with the actuator.

18. The device of claim 14, wherein the actuator comprises a deformable membrane.

19. The device of claim 14, wherein the actuator further comprises a clip engageable with the plugging device, wherein the clip can retain the plugging device in an open position.

20. The device of claim 18, wherein the lid further comprises a projection supporting the deformable membrane.
